(19) United States
(12) Patent Application Publication
(10) Pub. No.: US 2010/0071210 A1
(43) Pub. Date: Mar. 25, 2010

(54) METHODS FOR FABRICATING FACEPLATE OF SEMICONDUCTOR APPARATUS

(75) Inventors: TIEN FAK TAN, Fremont, CA (US); Lun Tsuei, Mountain View, CA (US); Shaofeng Chen, Austin, TX (US); Felix Rabinovich, Campbell, CA (US); Dmitry Lubomirsky, Cupertino, CA (US); Kimberly Hinckley, Mountain View, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/236,768

(22) Filed: Sep. 24, 2008

(51) Int. Cl. B05B 1/00; B05D 1/02; B05B 1/14; B21D 53/00

(52) U.S. Cl. 29/890.1

(57) ABSTRACT

A method for manufacturing a faceplate of a semiconductor apparatus is provided. The method includes selecting a size of a tool in response to a predetermined specification of a predetermined gas parameter. The tool is used to form the holes within the faceplate. A first gas parameter of the holes of the faceplate is measured by an apparatus to determine if the measured first gas parameter of the holes of the faceplate is within the predetermined specification.

### FIELD OF THE INVENTION

The invention relates to methods for fabricating a semiconductor apparatus. More particularly, the invention relates to methods for fabricating a faceplate of a semiconductor apparatus.

### BACKGROUND OF THE INVENTION

In the fabrication of electronic circuits and displays, materials such as semiconductor, dielectric and conductor materials, are deposited and patterned on a substrate. Some of these materials are deposited by chemical vapor deposition (CVD) or physical vapor deposition (PVD) processes, and others may be formed by oxidation or nitridation of substrate materials. For example, in chemical vapor deposition processes, a process gas is introduced into a chamber and energized by heat or RF energy to deposit a film on the substrate. In physical vapor deposition, a target is sputtered with process gas to deposit a layer of target material onto the substrate. In etching processes, a patterned mask comprising a photoresist or hard mask, is formed on the substrate surface by lithography, and portions of the substrate surface that are exposed between the mask features are etched by an energized process gas. The process gas may be a single gas or a mixture of gases. The deposition and etching processes, and additional planarization processes, are conducted in a sequence to process the substrate to fabricate electronic devices and displays.

The substrate processing chambers comprise gas distributors which have a plurality of gas nozzles to introduce process gas in the chamber. Conventionally, the gas distributor can be a showerhead comprising a faceplate or enclosure having a plurality of gas nozzles. An equipment vendor may request a shop to fabricate faceplates, such that the vendor can install the faceplates in deposition and etch equipment and ship the equipment to chip manufacturers.

Conventionally, a vendor provides a specification of a physical dimension of holes of faceplates to a shop. The shop then drills the holes based on the provided specification. The shop measures if the physical dimensions of the holes meet the specification provided by the vendor and ships the faceplates meeting the specification to the vendor. The vendor installs the faceplates to semiconductor apparatus, such as CVD or etching equipment, for distributing chemical gases. It is found that even if the physical dimensions of the faceplates meet the vendor's requirements, the faceplates may still fail because the faceplates cannot provide desired gas distribution conditions, such as gas flow, pressure and/or the like in a process. The vendor will return the failed faceplates even if they have holes that meet the vendor's physical dimension specification. Accordingly, methods for fabricating faceplates of semiconductor apparatus to solve the issue are desired.

### BRIEF SUMMARY OF THE INVENTION

Embodiments of the invention pertain to methods for fabricating faceplates of semiconductor apparatus. Unlike conventional methods, the methods of the embodiments can select a size of a tool for forming holes of the faceplates based on a specification of a gas parameter. By using the gas parameter to select the size of the tool to form the holes, the holes can provide a desired gas parameter for a semiconductor process.

One embodiment is a method for manufacturing a faceplate of a semiconductor apparatus. The method includes selecting a size of a tool according to a predetermined specification of a predetermined gas parameter. The tool is used to form the holes within the faceplate. A first gas parameter of the holes of the faceplate is measured by an apparatus to determine if the measured first gas parameter of the holes of the faceplate falls within the predetermined specification.

### BRIEF DESCRIPTION OF THE DRAWINGS

A further understanding of the nature and advantages of the invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a simplified flowchart showing an exemplary method for manufacturing a faceplate of a semiconductor apparatus according to an embodiment of the invention;

FIG. 2 is a flowchart showing an exemplary method with a bias correction for manufacturing a faceplate of a semiconductor apparatus according to an embodiment of the invention;

FIG. 3 is a simplified drawing showing a coupon according to an embodiment of the invention;

FIG. 4 is a simplified drawing showing an exemplary gas flow comparator according to an embodiment of the invention;

FIG. 5 is a perspective view of an exemplary gas flow comparator according to an embodiment of the invention; and

FIGS. 6A-6B illustrate a flowchart for measuring gas parameters of a coupon and a faceplate according to an embodiment of the invention.

### DETAILED DESCRIPTION OF THE INVENTION

The invention relates to methods for fabricating semiconductor apparatus. More particularly, the invention relates to methods for fabricating faceplates of semiconductor apparatus, such as CVD or etching apparatus. The method can include selecting a size of a tool in response to a predetermined specification of a predetermined gas parameter. The size of the tool can be selected to form the holes within the faceplate. Since the method uses the predetermined gas parameter as a specification for selecting the size of the tool to form the holes of the faceplate, the measured gas flow rate or gas pressure of the faceplate can substantially reflect a gas flow rate or gas pressure of a manufacturing process using the faceplate.

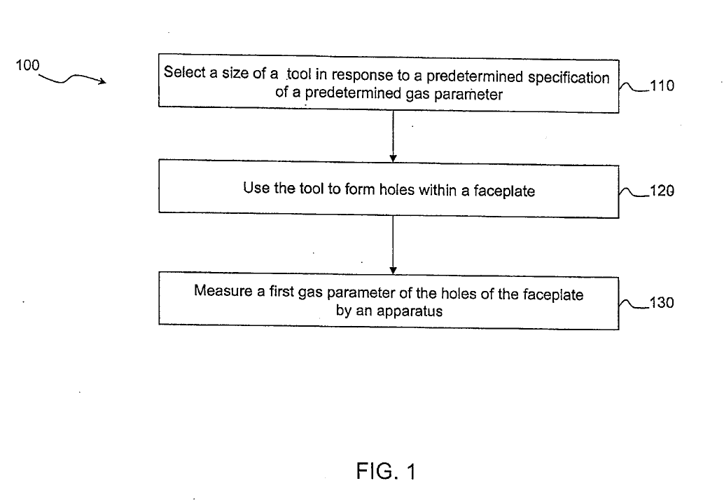

FIG. 1 is a simplified flowchart showing an exemplary method for manufacturing a faceplate of a semiconductor apparatus according to an embodiment of the invention. In FIG. 1, method 100 includes selecting a size of a tool in response to a predetermined specification of a predetermined gas parameter (step 110). The predetermined gas parameter can be, for example, a gas flow rate, a gas pressure and/or other gap parameter. In embodiments, the predetermined gas parameter can be provided based on a semiconductor manufacturing process, such as a deposition or etching process. Step 120 uses the selected tool to form, such as drill, a plurality of holes within the faceplate. In step 130, a gas parameter of the holes of the faceplate is measured by an apparatus. Unlike a conventional method using a physical dimensions of holes to select the size of the tool, e.g., a size of a drill head or a beam size of a laser, method 100 uses the gas parameter, e.g., a flow rate or flow pressure, to select the size of the tool such that the faceplate disposed with a semiconductor apparatus can provide a desired flow rate or flow pressure for processing substrates.

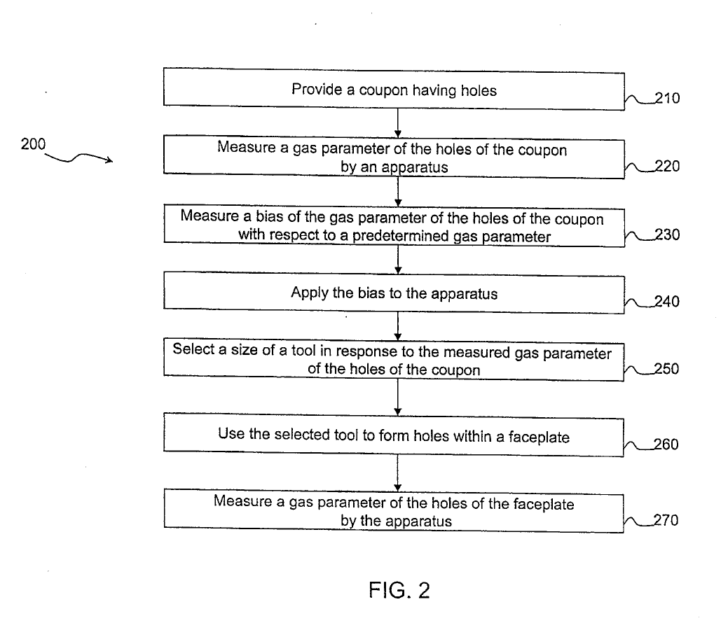

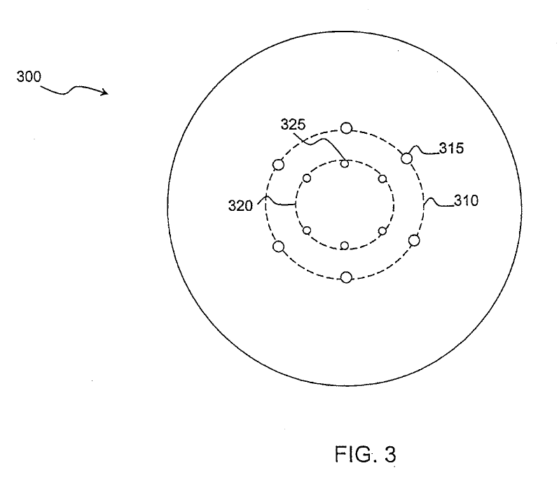

FIG. 2 is a flowchart showing an exemplary method with a bias correction for manufacturing a faceplate of a semiconductor apparatus according to an embodiment of the invention. In FIG. 2, a coupon or template having a plurality of holes is provided (step 210). A coupon can be a tangible metallic plate having a shape and dimension similar to a faceplate. An exemplary coupon according to an embodiment of the invention can be shown in FIG. 3. In FIG. 3, coupon 300 can include a plurality of holes arranged along bolt circles (BCs) around the center of coupon 300. The holes having different dimensions can be drilled in coupon 300 by various drill heads. In embodiments, coupon 300 can include at least one first hole 325 and at least one second hole 315. Holes 315 and 325 can be configured around the center of coupon 300 substantially along bolt circles (BCs) 310 and 320, respectively. In embodiments, holes 325 have a dimension of about 9 mil and holes 315 have a dimension of about 12 mil. It is noted that the numbers and dimensions of holes 315 and 325 shown in FIG. 3 are merely examples. Different numbers and dimensions of holes 315 and 325 can be used to measure the gas parameters provided by coupon 300. In addition, more circles of holes around the center of coupon 300 can be configured for measuring gas parameters. In embodiments, different tools are used to drill various holes in coupon 300. The gas parameter of each hole of coupon 300 is measured. The measured gas parameters are used to compare with a predetermined specification. If at least one of the measured gas parameters meets the predetermined specification, the tool used to drill the hole having the measured gas parameter within the specification can be selected.

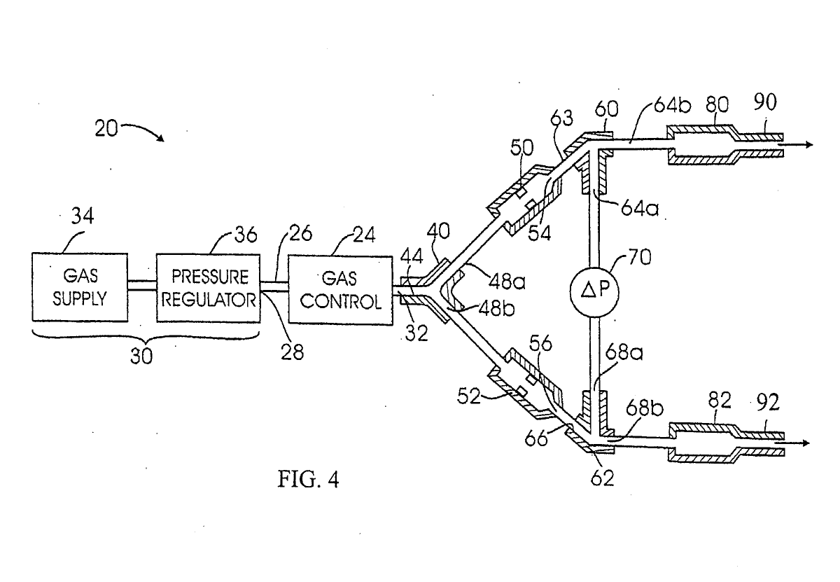

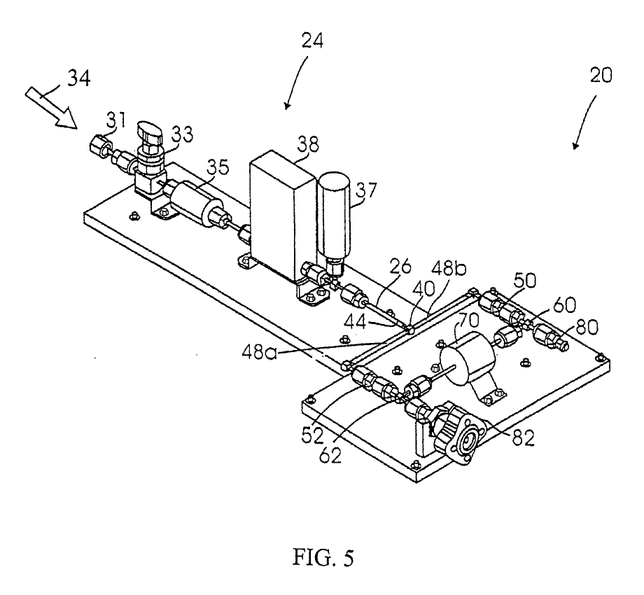

In step 220, a gas parameter of the holes of the coupon can be measured by an apparatus. For example, a gas flow rate measurement apparatus can be used to measure the gas flow rate of the holes of the coupon. The description of the gas flow rate measurement apparatus is provided below in conjunction with FIGS. 4-5.

In step 230, a bias of the gas parameter of the holes of the coupon with respect to a predetermined gas parameter is measured. The measured bias is then applied to the gas parameter apparatus to desirably offset errors for subsequent gas parameter measurements (step 240). For example, the bias can be resulted from defects of the holes drilled in the coupon, set-up of the measurement apparatus, defects of the drill heads selected for drilling the holes, and/or other factors that may be attribute to the bias. It is noted that step 240 may be optional if there is no bias or the measured bias is so small and can be ignored.

In step 250, a size of a tool, such as a drill head, is selected in response to the measured gas parameter of the holes of the coupon. The selected size of the tool is then used to drill holes within a faceplate (step 260). Gas parameters of the holes of the faceplate can be measured by the gas flow rate measurement apparatus (step 270).

Following is the description of an exemplary gas parameter measurement apparatus according to an embodiment of the invention. An embodiment of gas flow comparator 20, as shown in FIGS. 4 and 5, is capable of measuring a difference in a gas parameter of a gas passing through a plurality of nozzles via a pressure differential measurement. The measured gas parameter difference can be, for example, a flow rate or pressure of the gas. Flow comparator 20 can include gas control 24 mounted on gas tube 26 to set a gas flow rate or a gas pressure of the gas passing thorough tube 26. Gas tube 26 has inlet 28 connected to gas source 30 and outlet 32 through which the gas is passed out from gas tube 26. Gas source 30 can include gas supply 34, such as a pressurized canister of a gas and pressure regulator 36 to control the pressure of gas exiting the gas supply. In one embodiment, gas source 30 is set to provide a gas, such as for example, nitrogen, at a pressure of from about 50 psia to about 150 psia.

Gas control 24 provides gas at a selected gas flow rate or pressure to the apparatus. Referring to FIG. 5, the gas flow from a gas source (not shown) comes into gas tube 26 through gas coupler 31. Gas valve 33 on gas tube 26 is manually operated to set a gas flow through tube 26. The gas flow then passes through gas filter 35 which can be a conventional gas filter, such as those available from McMaster Carr, Atlanta, Ga. Gas control 24 can be, for example, a gas flow control or a gas pressure regulator. In one version, gas control 24 includes flow meter 38 such as a mass flow controller (MFC) or volumetric flow controller. Gas control 24 can include a gas flow control feedback loop to control a flow rate of gas passing through gas tube 26 which is commonly known as a flow control based mass flow meter. The flow rate set on flow meter 38 is the rate at which gas flows out of tube outlet 32 (shown in FIG. 4), and mass flow meter 38 monitors the gas flow rate and adjusts an internal or external valve in response to the measured flow rate to achieve a substantially constant flow rate of gas. By substantially constant it is meant a flow rate that varies by less than about 5%. Gas control 24 provides a substantially constant gas flow rate, for example, a flow rate that varies less than about 5% from a nominal flow rate. Suitable flow meter 38 is a mass flow controller (MFC), from Model No. 4400, about 300 sccm nitrogen, MFC from STE, Koyoto, Japan. In an embodiment, gas control 24 can include a pressure controlled MFC, such as an MFC rated at about 3000 sccm from MKS Instruments, Andover, Mass. Other suitable gas controls 24 can include MFCs from UNIT, Yuerba Linda, Calif. Yet another gas control 24 can include pressure regulator 36, such as a VARIFLO™ pressure regulator available from Veriflo, a division of Parker Hannifin Corporation, Cleveland, Ohio, or a pressure regulator from Swagelok, Solon, Ohio. Pressure display 37 is positioned after flow meter 38 to read the pressure of gas applied to gas flow comparator 20.

The gas at the constant flow rate and/or pressure is applied to principal flow splitter 40 which has inlet port 44 connected to outlet 32 of gas tube 26 to receive the gas. Flow splitter 40 splits the received gas flow to first and second output ports 48a and 48b. Flow splitter 40 can split the gas flow into two separate and equal gas flows or split the gas flow according to a predefined ratio. In one embodiment, flow splitter 40 can split the received gas flow equally between first and second output ports 48a and 48b. This can be accomplished by positioning output ports 48a and 48b symmetrically about inlet port 44. Principal flow splitter 40 can include a T-shaped gas coupler.

First and second flow restrictors 50, 52 are each connected to first and second output ports 48a and 48b, respectively. Each flow restrictor 50 or 52 provides a pressure drop across the flow restrictor. The pressure drop provided by each of the two restrictors 50, 52 is typically the same pressure drop, but they can also be different pressure drops. In one embodiment, first flow restrictor 50 has restrictor outlet 54 and second flow restrictor 52 has restrictor outlet 56. In embodiments, flow restrictor 50 can include a nozzle. Suitable flow restrictors 50, 52 include Ruby Precision Orifices available from BIRD Precision, Waltham, Mass.

A pair of secondary flow splitters 60, 62 are connected to restrictor outlets 54, 56 of flow restrictors 50, 52. First secondary flow splitter 60 can include inlet port 63 and a pair of first output ports 64a and 64b, and second secondary flow splitter 62 has inlet port 66 and a pair of second output ports 68a and 68b. Secondary flow splitters 60,62 can also comprise the aforementioned T-shaped gas couplers.

Differential pressure gauge 70 is connected across the output ports 64a, 68a of secondary flow splitters 60, 62. In one embodiment, differential pressure gauge 70 is suitable for measuring a pressure range of at least about 1 Torr, or even at least about 5 Torr, or even about 50 Torr. The accuracy of differential pressure gauge 70 depends on the pressure or flow rate of gas through flow comparator 20. For example, differential pressure gauge 70 having a pressure range measurement capability of about 50 Torr has an accuracy of at least about ±10.15 Torr; whereas differential pressure gauge 70 capable of measuring a pressure range of about 1 Torr has an accuracy of about 0.005 Torr. Suitable differential pressure gauge 70 can be an MKS 223B differential pressure transducer, available from aforementioned MKS Instruments, Inc. Differential pressure gauge 70 operates by diaphragm displacement in the forward or reverse direction which generates a positive or negative voltage which corresponds to the measured pressure differential.

First and second nozzle holders 80, 82 are connected to pair of second output ports 64b, 68b of secondary flow splitters 60, 62. Nozzle holders 80, 82 are capable of being connected to feed gas to nozzles 90, 92, for comparative measurements of the flow rates through the nozzles. For example, nozzle holders 80, 82 can be connected to first reference nozzle 90 and second test nozzle 92, which are to be tested for its flow rate relative to the reference nozzle; or the relative flow rates through two nozzles 90, 92 can be compared to one another. Additional details and examples of the flow comparator and gas parameter measuring methods may be found in co-assigned U.S. patent publication No. 2008/0000530, filed May 25, 2007, and titled “GAS FLOW CONTROL BY DIFFERENTIAL PRESSURE MEASUREMENTS” of which the entire contents of the application are herein incorporated by reference for all purposes.

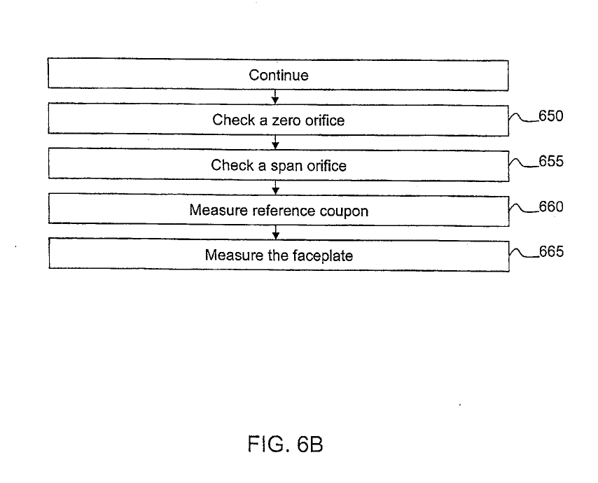

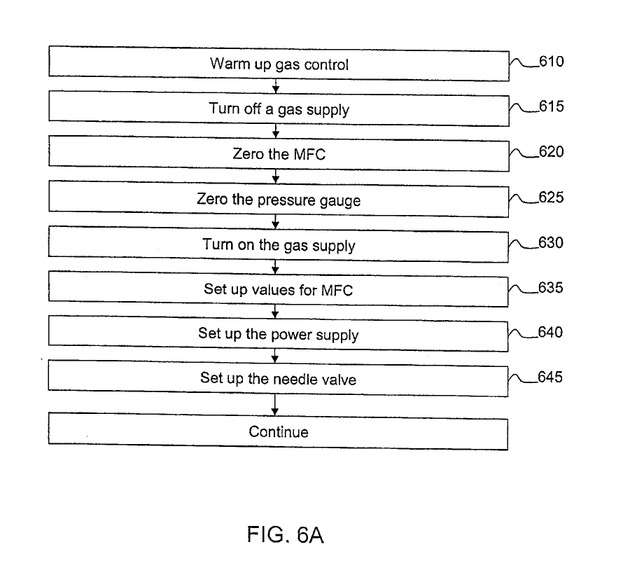

FIGS. 6A-6B illustrate a procedure for measuring gas parameters of a coupon and a faceplate according to an embodiment of the invention. In FIG. 6A, gas control 24 (shown in FIG. 5) can be warmed up for about 2 hours, for example (step 610). In step 615, gas supply 34 (shown in FIG. 5) can be turned off to remove the gas pressure in MFC 38 (shown in FIG. 5). In step 620, MFC 38 can be zeroed. Pressure gauge 70 (shown in FIG. 5) can be zeroed (step 625). Gas supply 34 can be turned on (step 630). In embodiments, gas supply 34 can be set to about 25±3 psig. MFC 38 can be set to about 500 sccm, for example (step 635). The power supply can be set. (step 640). Gas valve 33 (shown in FIG. 5) is set until a pressure readout is about 1.4 Torrs. (step 645).

In FIG. 6B, an orifice is checked (step 650). For example, a probe is inserted into a zero reference orifice and gas valve 33 is adjusted to provide a readout of about 0±0.005. In step 655, a span orifice is checked. For example, a probe can be inserted into a span orifice and gas valve 33 is adjusted to provide a readout of about 0.68±0.25. In step 660, a gas parameter of a coupon is measured. The coupon can include a plurality of holes configured along bolt circles (BCs) around the center of the coupon. For example, the coupon can be aligned first. 9-mil holes on a second bolt circle (BC) can be clockwise measured. Then, 12-mil holes on the fourth BC can be clockwise measured. After measuring the gas parameters of the coupon, steps 230-260 described above in conjunction with FIG. 2 can be provided to select a size of a tool used to form holes in a faceplate.

Following is the description of an exemplary schedule for measuring the gas parameters of the faceplate. In step 655, the gas parameters of the holes of the faceplate are measured. For example, the zero orifice and span orifice are checked. If the readout of checking the zero orifice is out of 0±0.005, steps 650-660 can be repeated. The faceplate is then aligned for measurement. One 8-mil hole at the center and eighteen 9-mil holes arranged along the second and third BCs of the faceplate are measured. Then, six 12-mil holes on the fourth BC and three 12-mil holes on the fifth and sixth BCs of the faceplate are measured. The pressure of each hole can be recorded. In embodiments, zero and/or span reference orifices are checked. If the zero orifice is outside of 0±0.005, steps 650-660 can be repeated. Twenty four holes arranged along an outer circle of the faceplate can be clockwise sampled and the back pressures of the holes are recorded. Sixteen holes and eight holes arranged along two circles around the center of the faceplate can then be clockwise sampled and a back pressure of each hole is recorded. The recorded back pressures are collected to measure an average standard deviation and delta values. The measured deviation and/or delta values can be compared with the predetermined specification of a gas parameter. In embodiments, the gas parameter can be a gas parameter of a semiconductor manufacturing process, such as a deposition or etching process. If the measured deviation and/or delta values are within the specification, the faceplate may be desired. If the measured deviation and/or delta values do not fall within the specification, the faceplate may be failed and can be fixed or waived.

It is noted that the procedure set forth above in conjunction with FIGS. 6A-6B is merely an example. One of ordinary skill in the art can modify the procedure to desirably measure the coupon and the faceplate. In addition, different hole dimensions, hole numbers, and readout values can be applied. The scope of the invention is not limited thereto.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the precursor” includes reference to one or more precursors and equivalents thereof known to those skilled in the art, and so forth.

Also, the words “comprise”, “comprising”, “include”, “including”, and “includes” when used in this specification and in the following claims are intended to specify the presence of stated features, integers, components, or steps, but they do not preclude the presence or addition of one or more other features, integers, components, steps, acts, or groups.

What is claimed is:

1. A method for manufacturing a faceplate of a semiconductor apparatus, comprising:
selecting a size of a tool according to a predetermined specification of a predetermined gas parameter;
using the tool to form the holes within the faceplate; and
measuring a first gas parameter of the holes of the faceplate by an apparatus to determine if the measured first gas parameter of the holes of the faceplate is within the predetermined specification.

2. The method of claim 1 wherein the predetermined gas parameter includes at least one of a gas flow rate and a gas pressure.

3. The method of claim 1 wherein the predetermined gas parameter is a gas parameter of a semiconductor manufacturing process.

4. The method of claim 1 wherein selecting the size of the tool comprises:
measuring a second gas parameter of holes of a coupon; and
determining if the measured second gas parameter is within the predetermined specification to select the size of the tool.

5. The method of claim 4 further comprising:
measuring a bias of the second measured gas parameter with respect to the predetermined gas parameter; and
applying the bias to the apparatus to measure the first gas parameter.

6. The method of claim 4 wherein the holes of the coupon include at least one first dimension hole and at least one second dimension hole, and the at least one first dimension hole and the at least one second dimension hole are disposed around the center of the coupon.

7. The method of claim 6 wherein the at least one first dimension hole has a dimension of about 9 mil and the at least one second dimension hole has a dimension of about 12 mil.

8. A method for manufacturing a faceplate of a semiconductor apparatus, comprising:
measuring a gas parameter of holes of a coupon according to a predetermined specification of a gas parameter of a semiconductor manufacturing process;
determining if the measured gas parameter of the coupon is within the predetermined specification to select a size of a tool;
using the tool to form the holes within the faceplate; and
measuring a gas parameter of the holes of the faceplate by an apparatus to determine if the measured gas parameter of the holes of the faceplate is within the predetermined specification.

9. The method of claim 8 wherein the gas parameter of the semiconductor manufacturing process includes at least one of a gas flow rate and a gas pressure.

10. The method of claim 8 further comprising:
measuring a bias of the measured gas parameter of the coupon with respect to the gas parameter of the semiconductor manufacturing process; and
applying the bias to the apparatus to measure the gas parameter of the faceplate.

11. The method of claim 8 wherein the holes of the coupon include at least one first dimension hole and at least one second dimension hole, and the at least one first dimension hole and the at least one second dimension hole are disposed around the center of the coupon.

12. The method of claim 11 wherein the at least one first dimension hole has a dimension of about 9 mil and the at least one second dimension hole has a dimension of about 12 mil.
